(19) United States
(12) Patent Application Publication
(10) Pub. No.: US 2007/0114350 A1
(43) Pub. Date: May 24, 2007

(54) Table accessory for supporting bags and the like

(76) Inventor: Valeria Sorci, Monte Porzio Catone (IT)

Correspondence Address: Leffert Jay & Polglaze, P.A., P. O. Box 581009, Minneapolis, MN, 55458-1009, US

(21) Appl. No.: 11/365,481

(22) Filed: Mar. 1, 2006

(30) Foreign Application Priority Data
Nov. 24, 2005 (IT) RM2005A000589

(51) Int. Cl. F16B 45/00

(52) U.S. Cl. 248/304

(57) ABSTRACT

A table accessory for supporting bags includes means for fastening the accessory to a plane of a table and a retaining member having an element for receiving a bag and an element for securing the bag to the table that is connected to the bag receiving element. The securing element is apt to cooperate with the plane so that when the bag is in the bag receiving element, the accessory assumes, by virtue of the weight of the bag, a first loaded configuration defined by the abutting of the securing element on a bottom surface of the plane, the plane being clamped between the fastening means and the securing element, and when the bag is removed from the bag receiving element, the accessory assumes a second unloaded configuration, where the securing element is unconstrained from the bottom surface.

### RELATED APPLICATIONS

This application claims priority to Italian Application No. RM2005A000589, filed Nov. 24, 2005, entitled “TABLE ACCESSORY FOR SUPPORTING BAGS AND THE LIKE.”

### TECHNICAL FIELD OF THE INVENTION

The present invention refers to the field of manufacturing accessories for pieces of furniture and in particular, to a table accessory for supporting bags and the like apt to provide an aid for placing and temporarily storing a generic load, like that represented by a luggage and leather-ware.

### BACKGROUND OF THE INVENTION

In public places such as restaurants, bars, offices, schools, etc. there is often little or no space intended for temporarily storing bags or luggage carried by an individual intending to stay for a prolonged time without being encumbered by the bags or luggage. One solution to the problem is to lay the bags or luggage on the floor, thereby occupying space otherwise used for walking, with the associated risk of hindering the transit of persons and things, e.g., in a restaurant-like venue of waiters, customers, trolleys, etc. Even when rooms or spaces are available for temporarily storing bags or luggage, the rooms or spaces are not always located in the immediate vicinity of the positions occupied by the persons who were carrying the bags or luggage. Thus, these persons temporarily lose direct control of the own bags or luggage in that expressly employed personnel of a particular establishment have control of the bags or luggage goods, with the entailed increase in managing costs. Hooks or the like are often applied to tables and the like for holding bags, but may entail drawbacks, such as the irremovability and the inability to adjust their configuration to the alternate conditions of loading/unloading with bags and the like.

For the reasons stated above, and for other reasons stated below which will become apparent to those skilled in the art upon reading and understanding the present specification, there is a need in the art for alternatives for temporarily storing bags or luggage.

### SUMMARY

The above-mentioned problems with temporarily storing bags or luggage and other problems are addressed by the present invention and will be understood by reading and studying the following specification.

There is a demand for a system allowing the practical arranging of bags and the like at the positions taken up by people who carry the bags, e.g., when these people reside adjacent pieces of furniture generally incorporating a plane, such as tables, counters, desks and the like. Hence, object of the present invention is to meet said demand.

As it will be made apparent by the following description, the table accessory for supporting bags according to the present invention is susceptible to simple manufacturing and particularly cost-effective production. The accessory according to the present invention is engineered so as to advantageously have very limited dimensions; the bags loaded thereon concomitantly remaining easily accessible.

A further advantage of the accessory, according to the present invention, lies in that a user can immediately and effectively benefit therefrom for positioning bags and the like while residing adjacent a piece of furniture to which the accessory is applied. Moreover, the accessory according to the present invention combines demands of practicability with pleasant aesthetic values.

### BRIEF DESCRIPTION OF THE DRAWINGS

Further advantages, as well as the features and the modes of employ of the present invention, will be made apparent in the following detailed description of two preferred embodiments thereof, given by way of example and without limitative purposes, and of variants thereof making reference to the figures of the annexed drawings, wherein:

FIG. 1A is a perspective view of a first preferred embodiment of the accessory, according to an embodiment of the present invention.

FIG. 1B is a top perspective view of a plane of a piece of furniture to which is applied the accessory of FIG. 1A in operating conditions, according to another embodiment of the present invention.

FIG. 1C is a partially sectional side perspective view of a detail of the piece of furniture of FIG. 1B at the applying of the accessory of FIG. 1A.

FIG. 2A is a side and top perspective view of a second preferred embodiment of the accessory mounted on a plane of a piece of furniture, according to another embodiment of the present invention.

FIG. 2B is a side and bottom perspective view of the accessory according to the present invention of FIG. 2A, according to another embodiment of the present invention.

FIG. 2C comprises a set of three perspective views of the accessory of FIG. 2A, said set being apt to exemplify a mode of deployment in an operating position of a retaining member for a bag and of closure in a non-operating position thereof, according to another embodiment of the present invention.

FIG. 3A is a side and top perspective view of a variant of the accessory of FIG. 2A, mounted on a shelf of a piece of furniture, according to another embodiment of the present invention.

FIG. 3B is a side and bottom perspective view of the accessory of FIG. 3A, according to another embodiment of the present invention.

FIG. 3C comprises a set of three perspective views of the accessory of FIG. 3A, said set being apt to exemplify a mode of deployment in an operating position of a retaining member for a bag and of closure in a non-operating condition thereof, according to another embodiment of the present invention.

### DETAILED DESCRIPTION

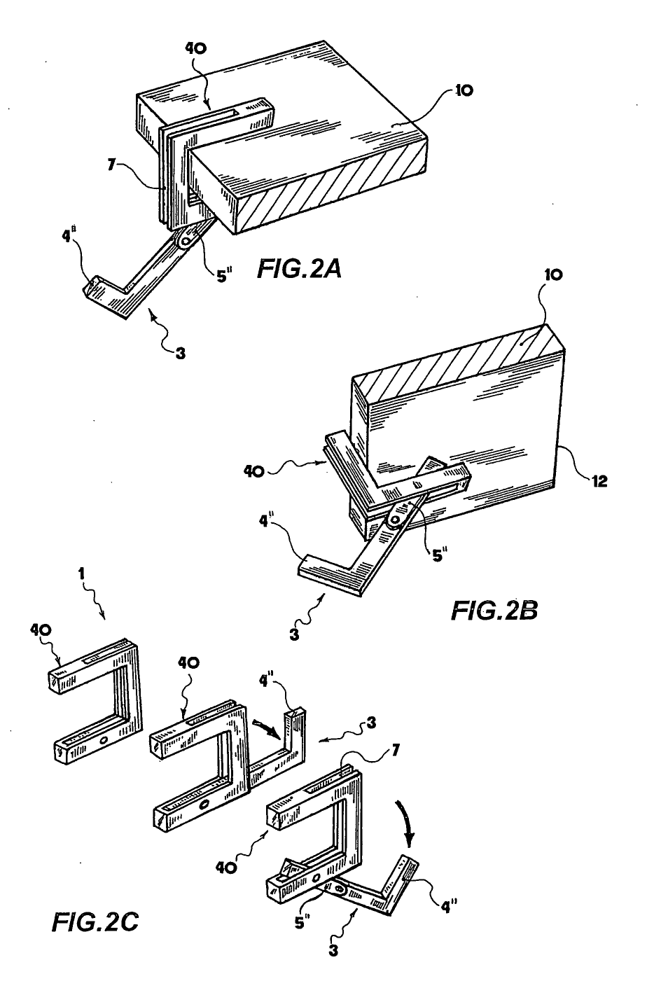

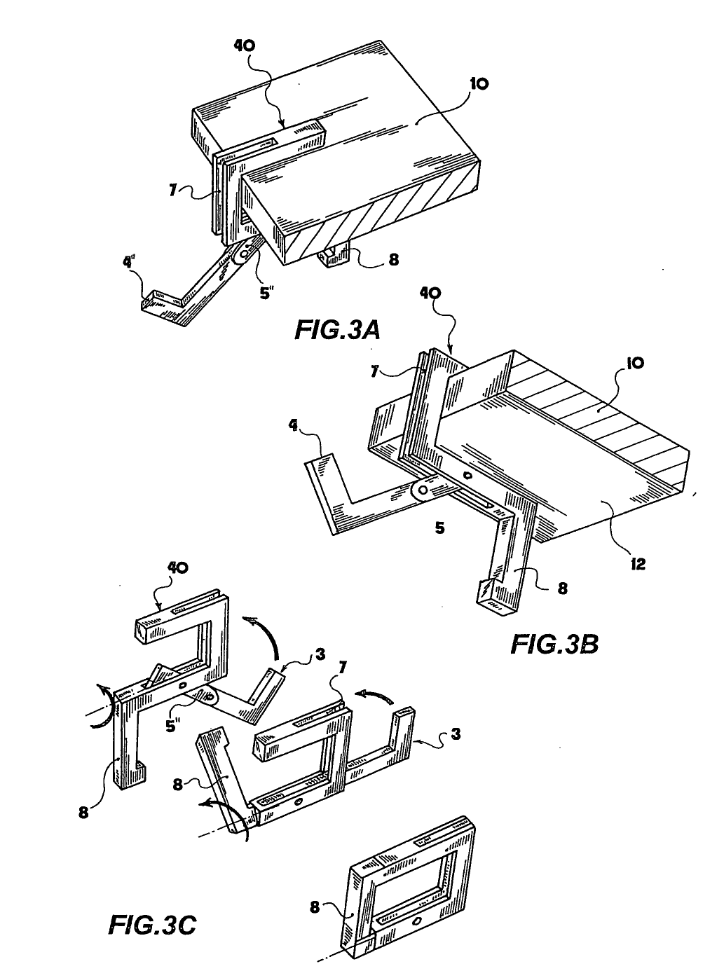

The structure of a table accessory 1, according to the present invention, as shown in FIGS. 2 and 3, comprises means for fastening table accessory 1 to a plane 10, e.g. the top of a table, and a retaining member 3 for a bag 100 or the like. Such a retaining member 3 has a first element 4′, 4″ for positioning and/or grabbing the bag 100, and a second element 5′, 5″ for securing the bag 100 to the plane 10 of the table.

The securing element 5′, 5″ is apt to cooperate with the plane 10, and the operation mechanism is conceived so as to provide a firm grip of the bag 100, located on said first positioning and/or grabbing element 4′, 4″, and assure a safe supporting thereof by the accessory 1 fastened to the plane 10. In particular, the operation dynamics provides that when the bag 100 is engaged in the positioning and/or grabbing element 4′, 4″, the accessory 1 assumes, by virtue of the weight force of the bag 100, a first loaded configuration defined by the abutting of the securing element 5′, 5″ on a bottom surface 12 of the plane 10. Thus, the portion of plane 10 to which the accessory 1 is applied is pinched between said fastening means and the securing element 5′, 5″.

When, instead, the bag 100 is removed from the positioning and/or grabbing element 4′, 4″, the accessory 1 assumes a second unloaded configuration, wherein the securing element 5′, 5″ is unconstrained from the bottom surface 12 of the plane 10. Thus, the slipping off of the bag 100 itself from the accessory 1 by the user and the restoring, automated or by a user of the retaining member 3, to the non-operating position are made easier.

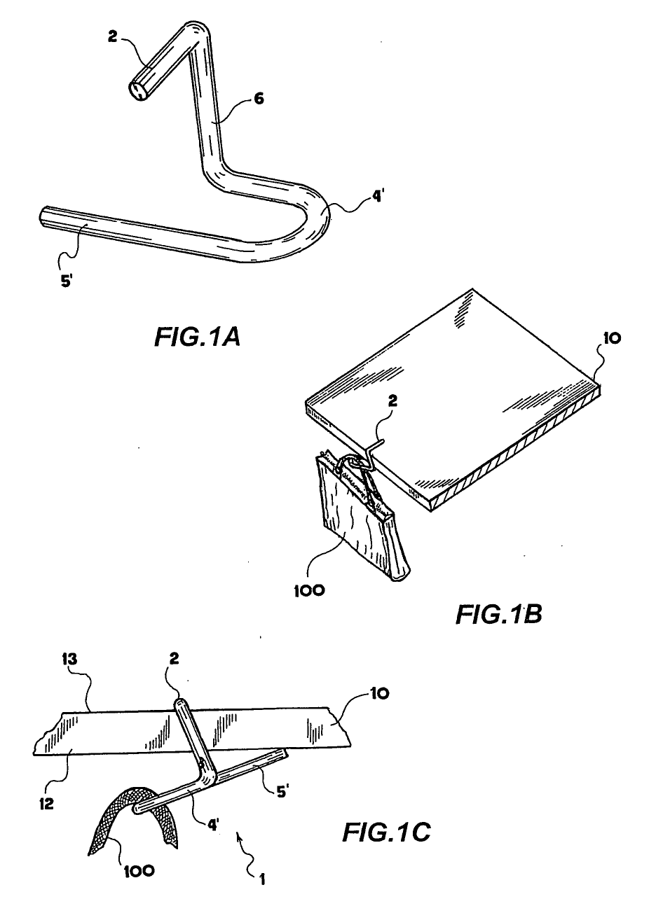

A first preferred embodiment of the accessory according to the present invention, exemplified in FIG. 1A, provides that the fastening means be integral with the retaining member. In this specific case, the fastening means comprises a basically cylindrical element 2 apt to rest on a top surface 13 of the plane 10. Such a basically cylindrical element 2 allows a rotation of the accessory 1 with regard to the table in connection with the loading of the accessory 1 with the weight of a bag 100.

As illustrated in FIG. 1A, the positioning and/or grabbing element has a basically curved portion 4′, e.g., loop-shaped, of the retaining member, made integral with the basically cylindrical element 2 through a fitting 6. The securing element is an extension bar 5′, integral with the loop 4′ of the retaining member. The configuration of the retaining member is such that, in the loaded configuration, the basically cylindrical element 2 rotates, under the weight of the bag 100, according to a first sense of rotation determining the tilt of the fitting 6 and therefore the abutting of one end of the bar 5′ onto the bottom surface 12. By virtue of such a configuration, it is prevented the slipping off of the bag 100, which thus remains stably hung, as shown in FIG. 1C, until the user decides to remove it by lifting it.

In the unloaded configuration, when the securing element 5′ is freed from the weight of the bag 100, the basically cylindrical element 2 rotates according to a second direction sense, opposite to said first sense of rotation, causing the detaching of the securing element 5′ from the bottom surface 12. Thus, it is allowed the removal of said bag 100 and/or the insertion of a further bag.

In a second embodiment of the accessory 1, according to the present invention, as depicted in FIGS. 2A to 2C, the fastening means comprises a basically C-shaped structure 40, apt to engage on the plane 10 of a table to which it is applied by insertion from an open side thereof. In this case, the securing element is a rod 5″ hinged to the basically C-shaped structure 40. The positioning and/or grabbing element 4″ is basically hook-shaped. In operation, the basically C-shaped structure 40 and the rod 5″ cooperate so as to strengthen the anchoring of the accessory 1 to the table by pinching the plane 10. The rod 5″ is preferably hinged to the hook 4″.

The at least two joints, preferably made with hinges, at the connection between rod 5″ and structure 40 and between rod 5″ and hook 4″, respectively, enables retaining member 3 to be reversibly folded back. As exemplified in FIG. 2C and in FIG. 3C, the retaining member 3 can be folded back, e.g., by jointing, in housings 7 obtained into the basically C-shaped structure 40, when in not in operation. Hence, the retaining member 3 is deployable from its housing into the basically C-shaped structure 40, to be thereby set in operation in order to allow the loading of a bag 100.

A variant of the table accessory 1, according to the present invention, envisages the insertion of an element 8 (FIGS. 3B and 3C) for closing the open side of the basically C-shaped structure 40. Such a closing element 8 has a C-like shape basically analogous to the structure 40, so as to couple to the ends of the structure 40. Thus, when the retaining member 3 is folded back and not engaged with the plane 10, the accessory 1 when not in operation appears basically shaped like a closed ring. Preferably, the closing element 8 is rotatably connected to one end of the structure 40, e.g. by a ball joint head.

Thanks to this design, the transportability of the accessory 1, which may optionally be removed from the plane 10 with ease, is advantageously facilitated. In particular, the accessory 1, provided with closing element 8, may convert to a user-wearable bracelet in its closed configuration. In both embodiments, the design incorporates ergonomic features and is such as to foster an advantageous removability of the accessory 1, so that the latter may easily be applied to the plane 10 or removed therefrom.

The use of a device according to the present invention may prove extremely convenient, e.g., in a working or private environment, where a shelf is available. The device finds useful in convivial contexts, like in restaurants or entertainment venues, or professional ones, like studies, in which a user has at his/her disposal a plane, e.g. of a table, shelf, stack or desk and wants to get rid of a load by putting it away in an orderly manner. The present invention may also be used in highly frequented public places such as teaching institutes, libraries, and offices attended by a consistent number of users equipped with respective bags apt to contain various documents and materials.

The present invention has hereto been described according to two preferred embodiments thereof, given by way of example and not for limitative purposes. It is understood that other embodiments may be envisaged as falling within the protective scope thereof, as defined by the appended claims.

What is claimed is:

1. A table accessory for supporting bags, comprising:
means for fastening said accessory to a plane of a table; and
a retaining member, comprising:
an element for receiving a bag; and
an element for securing said bag to said table that is connected to said bag receiving element and apt to cooperate with said plane so that when said bag is in said bag receiving element, said accessory assumes, by virtue of the weight of said bag, a first loaded configuration defined by the abutting of said securing element on a bottom surface of said plane, said plane being clamped between said fastening means and said securing element; and
when said bag is removed from said bag receiving element, said accessory assumes a second unloaded configuration, wherein said securing element is unconstrained from said bottom surface.

2. The table accessory according to claim 1, wherein said fastening means is integral with said retaining member.

3. The table accessory according to claim 2, wherein:
said fastening means comprises a basically cylindrical element, resting on a top surface of said plane, said basically cylindrical element being apt to allow a rotation of said accessory with regard to said table;
said bag receiving element has a basically curved portion integral with said basically cylindrical element; and
said securing element is an extension bar, integral with said bag receiving element, the configuration being such that, in said loaded configuration, said basically cylindrical element rotates in a first sense of rotation determining the abutting of said securing element on said bottom surface, so that it is prevented the slipping off of said bag; whereas, in said unloaded configuration, said basically cylindrical element rotates in a second sense of rotation, opposed to said first sense of rotation, causing the detaching of said securing element from said bottom surface, so that it is allowed the removal of said bag and/or the insertion of a another bag.

4. The table accessory according to claim 1, wherein said fastening means comprises a basically C-shaped structure, apt to engage on said plane of said table by insertion from an open side thereof; wherein said securing element is a rod hinged to said basically C-shaped structure, and wherein said bag receiving element is basically hook-shaped.

5. The table accessory according to claim 4, wherein said rod is hinged to said hook, the configuration being such that said retaining member is reversibly folded back into housings obtained into said basically C-shaped structure, when not in operation; and then deployable from said basically C-shaped structure, when in operation, in order to allow the loading of the bag.

6. The table accessory according to claim 5, further comprising an element for closing the open side of said basically C-shaped structure, so that, when not in operation with said retaining member folded back and not engaged on said plane of said table, said accessory appears basically shaped like a closed ring.
